(19) United States
(12) Patent Application Publication
(10) Pub. No.: US 2015/0170167 A1
(43) Pub. Date: Jun. 18, 2015

(54) ATTRIBUTE BASED RETAIL ASSORTMENT PLANNING

(71) Applicant: Oracle International Corporation, Redwood Shores, CA (US)

(72) Inventors: Ming LEI, Atlanta, GA (US); Catalin POPESCU, Atlanta, GA (US)

(73) Assignee: Oracle International Corporation, Redwood Shores, CA (US)

(21) Appl. No.: 14/132,097

(22) Filed: Dec. 18, 2013

(51) Int. Cl. G06Q 30/02

(52) U.S. Cl. CPC G06Q 30/0202

(57) ABSTRACT

A system that determines metrics for a new item in response to receiving new attributes of the new item further receives for a plurality of previous items, one or more metric values for each previous item, and one or more active attributes for each previous item. The system determines an average metric value for each active attribute of the previous items. The system then, for each of the new attributes, determines a geometric mean of the average metric values for corresponding active attributes that match the new attributes.

### FIELD

One embodiment is directed generally to a computer system, and in particular to a computer system that determines retail assortment planning.

### BACKGROUND INFORMATION

Retailers generally attempt to maximize profits or other performance metrics such as sales volume through different types of retail strategies. In order to keep current customers and gain additional customers, retailers invest in retail strategies to provide an appealing arrangement of products on display. For example, retail assortment planning is a strategy used to specify a set or an assortment of products carried by a retailer that meets the customers' product preferences. Retail assortment planning may encompass selecting an assortment of products to offer for sale that would maximize a selected performance metric.

However, despite engaging in retail assortment planning, retailers regularly lose volume and profits on unpopular products. One reason is the difficulty in determining how a deletion or an addition of a product or a multitude of products affects an overall performance metric, such as profits or sales volume, of an assortment of products. For example, retailers either assume all sales volume is lost when a product is deleted from an assortment of products or estimate how much sales volume may be lost when a product is deleted from the assortment of products based on the importance of the products. However, with both of these methods, it is difficult to determine which assortment of products is best for the store because the assumption that all sales volume is lost and the estimation of lost sales volume based on the importance of the products may be inaccurate.

### SUMMARY

One embodiment is a system that determines metrics for a new item in response to receiving new attributes of the new item. The system further receives for a plurality of previous items, one or more metric values for each previous item, and one or more active attributes for each previous item. The system determines an average metric value for each active attribute of the previous items. The system then, for each of the new attributes, determines a geometric mean of the average metric values for corresponding active attributes that match the new attributes.

### BRIEF DESCRIPTION OF THE DRAWINGS

FIG. 1 is a block diagram of a computer server/system in accordance with an embodiment of the present invention.

FIG. 2 is a flow diagram of the functionality of assortment planning module of FIG. 1 when determining metrics for a new item added to a retail assortment.

### DETAILED DESCRIPTION

One embodiment determines metrics that will result from the introduction of a new product based on each individual attribute of the new product. Predetermined metrics for each of the individual attributes based on previous products can be used with the new product to determine the new metrics.

As described above, in order to meet consumer's evolving demand, retailers constantly change their assortment by removing obsolete items and adding new items. While removing items may be a straightforward process, managing new items can be very challenging. Among other things, retailers typically need to determine the inventory levels of a new item that need to be carried to ensure a certain service level, how sensitive the new item is to a promotion, how will its sales react to a price change, what is its future demand going to be, etc. These and many other questions need to be answered to ensure that the new item delivers the expected return on investment. Known approaches for determining these metrics for a new item typically include determining a similar or “like item”, and using the metrics from that item for the new item.

In contrast, embodiments of the present invention use an attribute based approach to determine metrics for a new item added to a product assortment. A new item to be introduced in an assortment is associated with multiple attributes that make it unique. However, even though the new item is unique, some of its attributes can be found in items that already exist.

For example, a grocer may decide to introduce a new flavor of yogurt. Even though the flavor may be unique, attributes such as the size of the yogurt, the fat content and the brand is shared by other products. Further, the item may only come in packs of four, which is also an attribute it can have in common with other products. Embodiments compare the new item's attributes with attributes of related items, and derives the necessary metrics based on them.

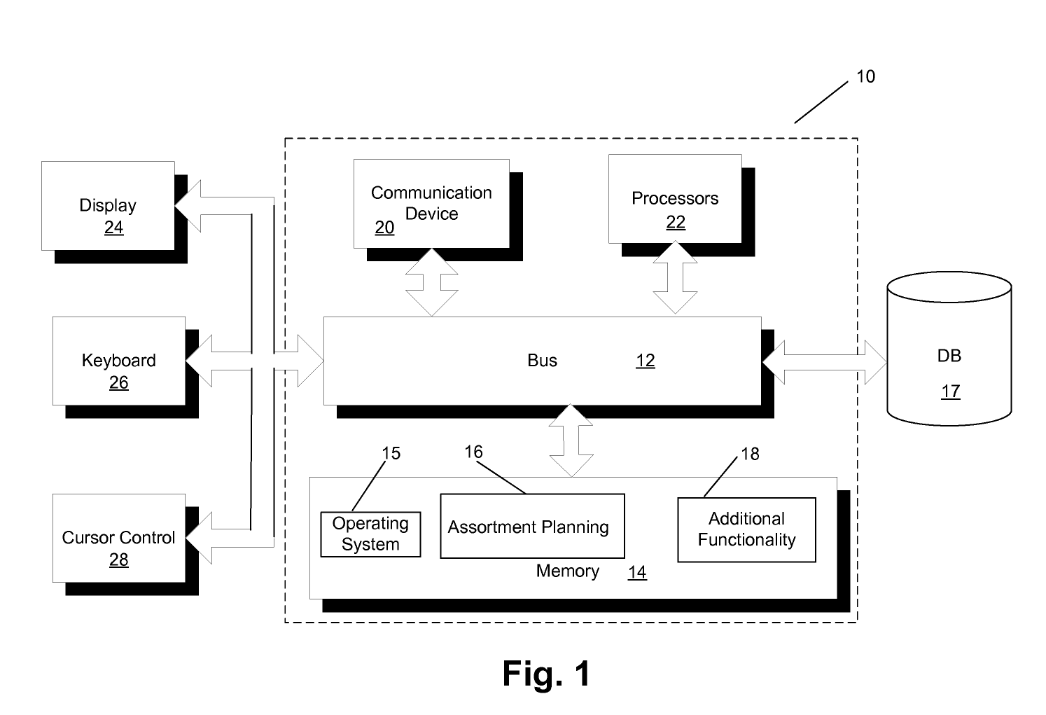

FIG. 1 is a block diagram of a computer server/system 10 in accordance with an embodiment of the present invention. Although shown as a single system, the functionality of system 10 can be implemented as a distributed system. Further, the functionality disclosed herein can be implemented on separate servers or devices that may be coupled together over a network. Further, one or more components of system 10 may not be included. For example, for functionality of a user client, system 10 may be a smartphone that includes a processor, memory and a display, but may not include one or more of the other components shown in FIG. 1.

System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication device 20, such as a network interface card, to provide access to a network. Therefore, a user may interface with system 10 directly, or remotely through a network, or any other method.

Computer readable media may be any available media that can be accessed by processor 22 and includes both volatile and nonvolatile media, removable and non-removable media, and communication media. Communication media may include computer readable instructions, data structures, program modules, or other data in a modulated data signal such as a carrier wave or other transport mechanism, and includes any information delivery media.

Processor 22 is further coupled via bus 12 to a display 24, such as a Liquid Crystal Display (“LCD”). A keyboard 26 and a cursor control device 28, such as a computer mouse, are further coupled to bus 12 to enable a user to interface with system 10.

In one embodiment, memory 14 stores software modules that provide functionality when executed by processor 22. The modules include an operating system 15 that provides operating system functionality for system 10. The modules further include an assortment planning module 16 for determining metrics for a new item added to a retail assortment, and all other functionality disclosed herein. System 10 can be part of a larger system, such as a demand forecasting system or a planning system. Therefore, system 10 can include one or more additional functional modules 18 to include the additional functionality, such as “Retail Promotion Planning and Optimization” from Oracle Corp. A database 17 is coupled to bus 12 to provide centralized storage for modules 16 and 18.

Embodiments determine metrics of a new item by determining the attributes of the new item, and using attribute-based metrics of prior items. For example, assume a retailer carries four items, item 1 thru item 4, and the items can have one or more of the following four attributes: “A”, “B”, “C”, or “D”. If the items are different varieties of yogurt or sour cream, for example, the attributes may be flavor, size, fat percentage and brand.

Table 1 below illustrates this example. For every item, an “x” indicates which attributes are active (i.e., are present in the item), and the value of the metric for the item. In the simplified example of Table 1, the metric is “rate of sale”, but embodiments can include as many metrics as needed. The rate of sale is the average amount an item sells per week or during any other timeframe. For example, a rate of sale of 4 means that the sales in a given week can be 3, 4, 5, etc., but the average is 4 units per week.

TABLE 1

| | |
|---|---|
| Metric | Attribute |

| Item | rate of sale | A | B | C | D |
|---|---|---|---|---|---|
| item 1 | 4.00 | x | | x | |
| item 2 | 3.00 | | x | x | x |
| item 3 | 4.00 | x | x | x | |
| item 4 | 5.00 | x | x | | |
| average by | | 4.33 | 4.00 | 3.67 | 3.00 |
| attribute | | | | | |
| item new | 3.63 | x | | x | x |

As shown in Table 1, item 1 has a rate of sale of 4 units, and attributes A and C. Item 2 has a rate of sale of 3 units and attributes B, C, and D. Item 3 has a rate of sale of 4 units and attributes A, B and C. Item 4 has a rate of sale of 5 units and attributes A and B.

After receiving the data of Table 1, embodiments then determine the average value of the metric by attribute. In one embodiment, for each attribute, it is first determined for which items it is active. Then, the metric values are averaged to get the value by attribute. For example, for attribute A, it is active for item 1, item 3, and item 4. Therefore, the average of the rate of sale metric for attribute A is (4+4+5)/3=4.33 units. Similarly, attribute B is active for item 2, item 3, and item 4. The average rate of sale for attribute B becomes: (3+4+5)/3=4 units. Only one item has attribute D, so the rate of sales for attribute D is the rate of sale of item 2, or 3.00 units.

Once the metrics by attribute has been determined, they can be applied to a new item, referred to as “item new”. When the retailer creates item new, the retailer also assigns it attributes in most retail planning systems. Assume attributes A, C, and D are active/assigned for item new. To calculate a rate of sale for item new, embodiments calculate the geometric mean of all relevant attribute values. The geometric mean is a type of mean or average which indicates the central tendency or typical value of a set of numbers by using the product of their values (as opposed to the arithmetic mean which uses their sum). The geometric mean is defined as the nth root (where n is the count of numbers) of the product of the numbers.

In the above example, the geometric mean of the values for attributes A, C, and D needs to be calculated:

rate of sale for ‘item new’=\sqrt{4.33*3.67*3.00}=3.63

Embodiments would make this determination for every desired metric for item new.

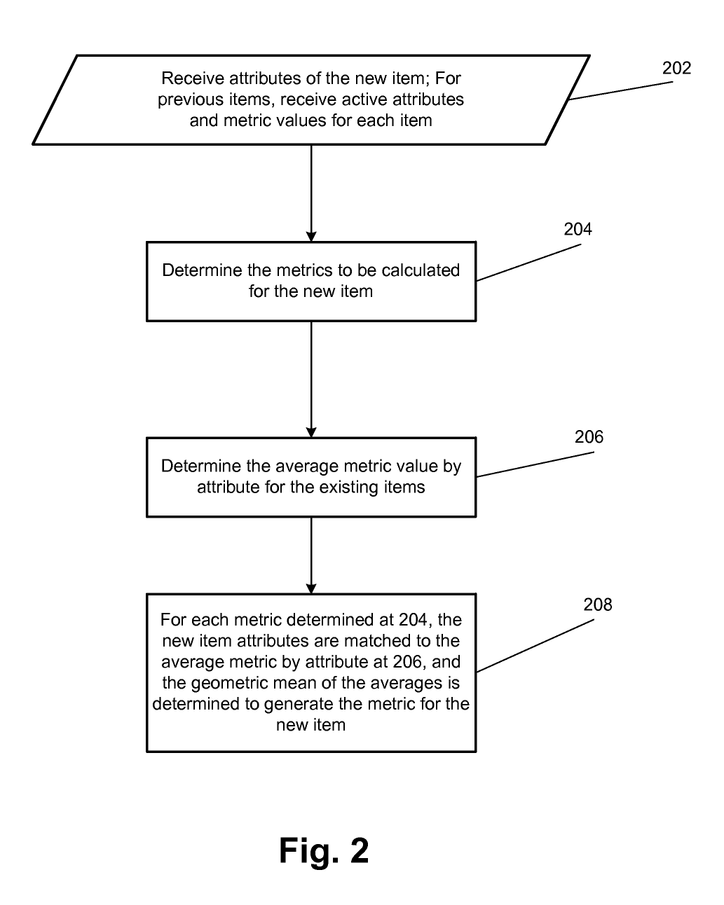

FIG. 2 is a flow diagram of the functionality of assortment planning module 16 of FIG. 1 when determining metrics for a new item added to a retail assortment. In one embodiment, the functionality of the flow diagram of FIG. 2 is implemented by software stored in memory or other computer readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

At 202, a new item is introduced into system 10 by the retailer. The attributes of the new item, such as size, color, brand, flavor, fat content, etc., are received and/or determined by the retailer and also entered into system 10. For previous items, active attributes and metric values for each item are received or retrieved.

At 204, the metrics to be calculated for the new item are determined. Example metrics include base demand, price elasticity, promotion lift, seasonality, sales volume and/or profits, gross margin, adjusted gross margin, contribution margin, consumer loyalty, etc.

At 206, the average metric value by attribute for existing items is determined based on previously received items, a metric value for each item, and one or more active attributes for each item.

At 208, the new item attributes are matched to the average metric by attribute at 206, and the necessary metrics for the new item are determined as the geometric mean of the averages.

As disclosed, embodiments determine an average by attribute for each metric of a new item based on previous items. The attribute-based approach in accordance with embodiments of the present invention is more accurate and allows for a high degree of automation in comparison to the known “like item” approach. For example, assume a retailer introduces 300 new items every month, which is typical in fashion retail. In order to manage these new items, a retailer needs to evaluate what like item is appropriate for each of the new items using known methods. This is a very long and tedious process, and it is very easy to get it wrong.

In contrast, the attribute-based approach in accordance with embodiments of the present invention requires minimal user input. Once the attributes of the new items are known, and these are typically known when an item is created, embodiments automatically calculate all necessary metrics for the new items. The generated metrics can then be used as inputs to a demand forecasting system to forecast sales of the new item, a planning system to determine the item's lifecycle curve for better replenishment, promotion, and markdown strategies, or any other system or method that utilizes metrics.

Several embodiments are specifically illustrated and/or described herein. However, it will be appreciated that modifications and variations of the disclosed embodiments are covered by the above teachings and within the purview of the appended claims without departing from the spirit and intended scope of the invention.

What is claimed is:

1. A computer-readable medium having instructions stored thereon that, when executed by a processor, cause the processor to determine metrics for a new item, the determining comprising:
receiving a plurality of new attributes of the new item;
receiving for a plurality of previous items, one or more metric values for each previous item, and one or more active attributes for each previous item;
determining an average metric value for each active attribute of the previous items; and
for each of the new attributes, determining a geometric mean of the average metric values for corresponding active attributes that matches the new attributes.

2. The computer-readable medium of claim 1, wherein the one or more active attributes comprise at least one of size, color, brand or flavor.

3. The computer-readable medium of claim 1, wherein the one or more metric values comprise at least one of demand, price elasticity, promotion lift, seasonality, sales volume, profits or margin.

4. The computer-readable medium of claim 1, wherein determining the geometric mean comprises determining an nth root of a product of the average metric values, wherein n is the number of average metric values.

5. The computer-readable medium of claim 1, further comprising determining a forecast for the new item using the geometric means of the new attributes.

6. The computer-readable medium of claim 1, further comprising providing the geometric means of the new attributes to a retail planning system.

7. The computer-readable medium of claim 1, wherein the new item is an item to be sold at a retail store, and the previous items are items currently sold at the retail store.

8. A method for determining metrics for a new item, the determining comprising:
receiving a plurality of new attributes of the new item;
receiving for a plurality of previous items, one or more metric values for each previous item, and one or more active attributes for each previous item;
determining an average metric value for each active attribute of the previous items; and
for each of the new attributes, determining a geometric mean of the average metric values for corresponding active attributes that matches the new attributes.

9. The method of claim 8, wherein the one or more active attributes comprise at least one of size, color, brand or flavor.

10. The method of claim 8, wherein the one or more metric values comprise at least one of demand, price elasticity, promotion lift, seasonality, sales volume, profits or margin.

11. The method of claim 8, wherein determining the geometric mean comprises determining an nth root of a product of the average metric values, wherein n is the number of average metric values.

12. The method of claim 8, further comprising determining a forecast for the new item using the geometric means of the new attributes.

13. The method of claim 8, further comprising providing the geometric means of the new attributes to a retail planning system.

14. The method of claim 8, wherein the new item is an item to be sold at a retail store, and the previous items are items currently sold at the retail store.

15. A retail planning system comprising:
a processor;
a storage device coupled to the processor and storing a plurality of modules, the modules comprising:
a receiving module that receives a plurality of new attributes of a new item and receives for a plurality of previous items, one or more metric values for each previous item, and one or more active attributes for each previous item;
an averaging module that determines an average metric value for each active attribute of the previous items; and
a metric generation module that, for each of the new attributes, determines a geometric mean of the average metric values for corresponding active attributes that matches the new attributes, the geometric means comprising new metrics for the new item.

16. The retail planning system of claim 15, wherein the one or more active attributes comprise at least one of size, color, brand or flavor.

17. The retail planning system of claim 15, wherein the one or more metric values comprise at least one of demand, price elasticity, promotion lift, seasonality, sales volume, profits or margin.

18. The retail planning system of claim 15, wherein determining the geometric mean comprises determining an nth root of a product of the average metric values, wherein n is the number of average metric values.

19. The retail planning system of claim 15, further comprising determining a forecast for the new item using the geometric means of the new attributes.

20. The retail planning system of claim 15, further comprising providing the geometric means of the new attributes to a retail planning system.
